(19) United States
(12) Patent Application Publication
(10) Pub. No.: US 2023/0339681 A1
(43) Pub. Date: Oct. 26, 2023

(54) STORAGE SYSTEM, METHODS AND DEVICES

(71) Applicant: Ocado Innovation Limited, Hatfield, Hertfordshire (GB)

(72) Inventor: Robert STADIE, Hatfield, Hertfordshire (GB)

(73) Assignee: Ocado Innovation Limited, Hatfield, Hertfordshire (GB)

(21) Appl. No.: 18/041,233

(22) PCT Filed: Jul. 28, 2021
(86) PCT No.: PCT/EP2021/071162

§ 371 Date: Feb. 10, 2023

(30) Foreign Application Priority Data
Aug. 13, 2020 (GB) 2012672.8
Aug. 13, 2020 (GB) 2012673.6
Aug. 13, 2020 (GB) 2012675.1

(51) Int. Cl. B65G 1/04

(52) U.S. Cl. CPC B65G 1/0492; B65G 1/0478; B65G 1/0471; B65G 2203/0216; B65G 2203/046; B65G 2203/041

(57) ABSTRACT

A load handling device for operating in a storage system, a floor of the storage system including a network of tracks, or track network, based on a grid system, the tracks including a first set of track members extending in a first (x-) direction, and a second set of track members extending in a second (y-) direction, the second set of track members running transversely to the first set of track members in a substantially horizontal plane. The load handling device includes: a first set of wheels and a second set of wheels; and a support pad for receiving a storage container which support pad can be raised and or lowered in a vertical (z-) direction.

### FIELD OF THE INVENTION

The invention relates to a storage system, method and devices. More specifically, the invention relates to an automated article storage and retrieval system, method and related devices.

### BACKGROUND AND RELATED ART

Methods of handling containers stacked in rows have been well known for decades. Some such systems, for example as described in U.S. Pat. No. 2,701,065, to Bertel, comprise free-standing stacks of containers arranged in rows in order to reduce the storage volume associated with storing such containers but yet still provide access to a specific container if required. Access to a given container is made possible by providing relatively complicated hoisting mechanisms which can be used to stack and remove given containers from stacks. The costs of such systems are, however, impractical in many situations and they have mainly been commercialised for the storage and handling of large shipping containers.

The concept of using free-standing stacks of containers and providing a mechanism to retrieve and store specific containers has been developed further, for example as described in EP 0767113 B to Cimcorp. EP'113 discloses a mechanism for removing a plurality of stacked containers, using a robotic load handler in the form of a rectangular tube which is lowered around the stack of containers, and which is configured to be able to grip a container at any level in the stack. In this way, several containers can be lifted at once from a stack. The movable tube can be used to move several containers from the top of one stack to the top of another stack, or to move containers from a stack to an external location and vice versa. Such systems can be particularly useful where all of the containers in a single stack contain the same product (known as a single-product stack).

In the system described in EP'113, the height of the tube has to be at least as high as the height of the largest stack of containers, so that the highest stack of containers can be extracted in a single operation. Accordingly, when used in an enclosed space such as a warehouse, the maximum height of the stacks is restricted by the need to accommodate the tube of the load handler.

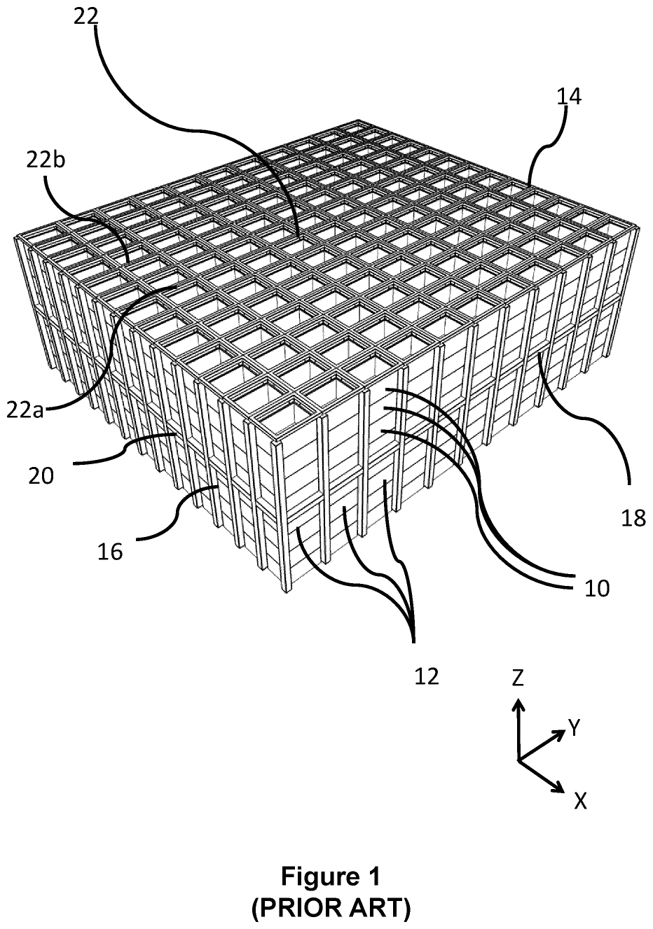

EP 1037828 B1 (Autostore) describes a system in which stacks of containers are arranged within a frame structure. A system of this type is illustrated schematically in FIGS. 1 to 4 of the accompanying drawings. Robotic load handling devices can be controllably moved around the stack on a system of tracks on the uppermost surface of the stack.

A load handling device is described in UK Patent Application No. GB2520104A—Ocado Innovation Limited—where each robotic load handler only covers one grid space, thus allowing high density of load handlers and thus high throughput of a given size system.

In the known robotic picking systems described above, robotic load handling devices are controllably moved around the top of the stacks on a track system forming a grid. A given load handling device lifts a bin from the stack, the container being lifted containing inventory items needed to fulfil a customer order. The container is carried to a pick station where the required inventory item may be manually removed from the bin and placed in a delivery container, the delivery container forming part of the customer order, and being manually filled for dispatch at the appropriate time. At the pick station, the items may also be picked by industrial robots, suitable for such work, for example as described in UK Patent Application No GB2524383B—Ocado Innovation Limited.

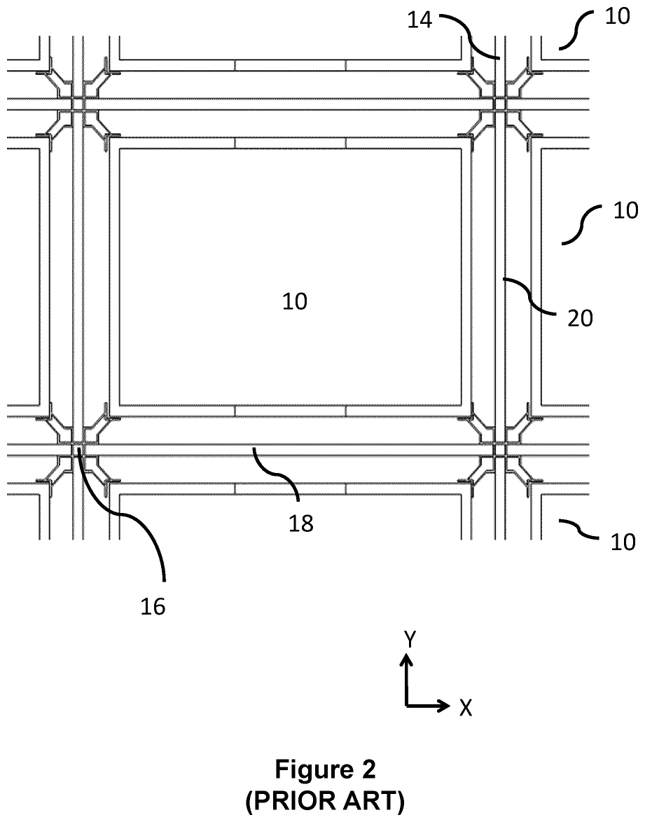

As shown in FIGS. 1 and 2, stackable storage containers, known as bins 10, are stacked on top of one another to form stacks 12. The stacks 12 are arranged in a framework 14 in a warehousing or manufacturing environment. FIG. 1 is a schematic perspective view of the framework 14, and FIG. 2 is a top-down view showing a single stack 12 of bins 10 arranged within the framework 14. Each bin 10 typically holds a plurality of product or inventory items, and the inventory items within a bin 10 may be identical, or may be of different product types depending on the application. Furthermore, the bins 10 may be physically subdivided to accommodate a plurality of different inventory items.

The framework 14 comprises a plurality of upright members 16 that support horizontal members 18, 20. A first set of parallel horizontal members 18 is arranged perpendicularly to a second set of parallel horizontal members 20 to form a plurality of horizontal grid structures supported by the upright members 16. The members 16, 18, 20 are typically manufactured from metal. The bins 10 are stacked between the members 16, 18, 20 of the framework 14, so that the framework 14 guards against horizontal movement of the stacks 12 of bins 10, and guides vertical movement of the bins 10.

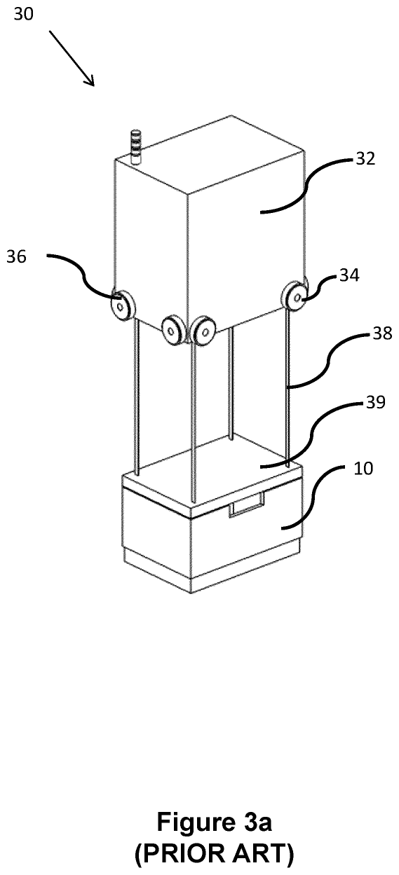

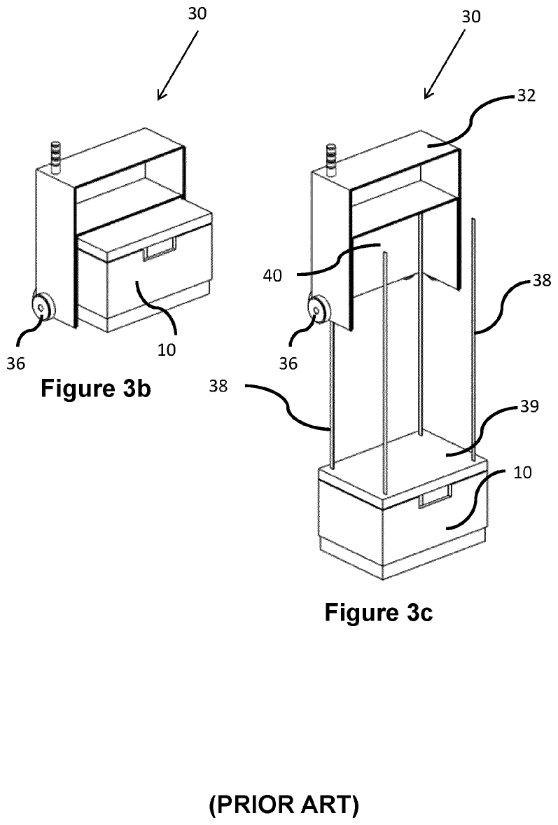

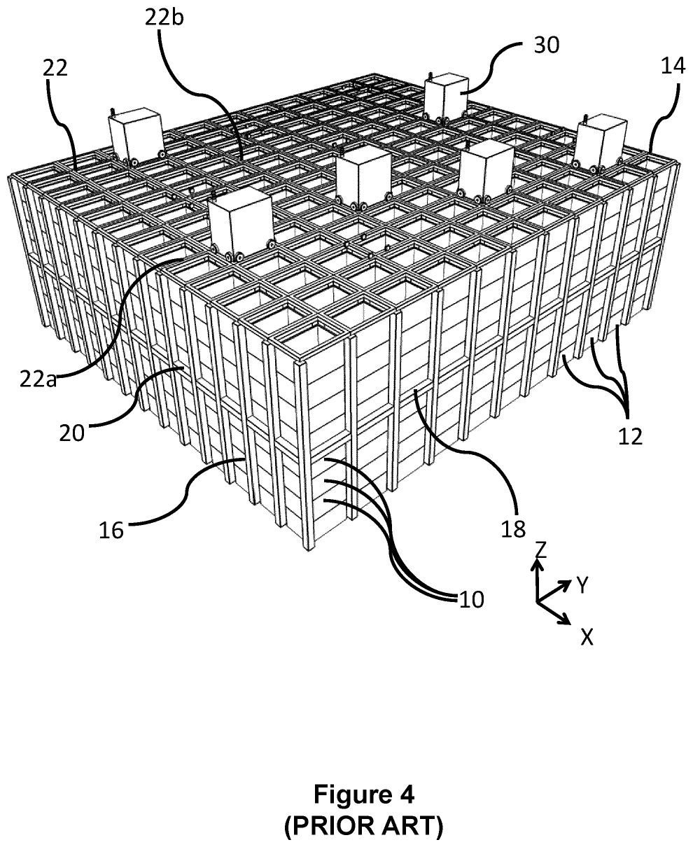

The top level of the framework 14 includes rails 22 arranged in a grid pattern across the top of the stacks 12. Referring additionally to FIGS. 3 and 4, the rails 22 support a plurality of robotic load handling devices 30. A first set 22a of parallel rails 22 guide movement of the load handling devices 30 in a first direction (X) across the top of the framework 14, and a second set 22b of parallel rails 22, arranged perpendicular to the first set 22a, guide movement of the load handling devices 30 in a second direction (Y), perpendicular to the first direction. In this way, the rails 22 allow movement of the load handling devices 30 in two dimensions in the X-Y plane, so that a load handling device 30 can be moved into position above any of the stacks 12.

Each load handling device 30 comprises a vehicle 32 which is arranged to travel in the X and Y directions on the rails 22 of the framework 14, above the stacks 12. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. Each set of wheels 34, 36 can be lifted and lowered, so that either the first set of wheels 34 or the second set of wheels 36 is engaged with the respective set of rails 22a, 22b at any one time.

When the first set of wheels 34 is engaged with the first set of rails 22a and the second set of wheels 36 are lifted clear from the rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the rails 22, and the second set of wheels 36 are lowered into engagement with the second set of rails 22a. The drive mechanism can then be used to drive the second set of wheels 36 to achieve movement in the Y direction.

In this way, one or more robotic load handling devices 30 can move around the top surface of the stacks 12 on the framework 14, as shown in FIG. 4 under the control of a centralised control utility (not shown). Each robotic load handling device 30 is provided with lifting means 38 for lifting one or more bins 10 from the stack 12 to access the required products.

The body of the vehicle 32 comprises a cavity 40, the cavity 40 being of a size capable of holding a bin 10. The lifting means 38 comprises winch means and a bin gripper assembly 39. The lifting means lifts a bin 10 from the stack 12 to within the cavity 40 within the body of the vehicle 32. When in the cavity 40, the bin 10 is lifted clear of the rails beneath, so that the load handling device can move laterally to a different location on the grid. On reaching the target location, for example another stack, an access point in the storage system or a conveyor belt, the bin 10 can be lowered from the cavity and released from the gripper assembly 39.

In this way, multiple products can be accessed from multiple locations in the grid and stacks at any one time.

The above description describes a storage system in connection with, for example, groceries. FIG. 4 shows a typical such storage system, the system having a plurality of load handling devices 30 active on the grid above the stacks 12.

FIGS. 1 and 4 show the bins 10 in stacks 12 within the storage system. It will be appreciated that there may be a large number of bins 10 in any given storage system and that many different items may be stored in the bins 10 in the stacks 12. Each bin 10 may contain different categories of inventory items within a single stack 12.

In one system described above and further in UK Patent Application Number GB2517264A—Ocado Innovation Limited, hereby incorporated by reference—the storage system comprises a series of bins 10 that may further comprise delivery containers DT with customer orders contained therein or may further comprise bins 10 with inventory items awaiting picking contained therein. These different bins 10 and combinations thereof may be contained in the storage system and be accessed by the robotic load handling devices 30 as described above.

It will be appreciated that automated or semi-automated storage and retrieval systems are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types will have different technical requirements.

It is against this background that the present invention has been devised.

The present disclosure describes systems, methods and devices for providing an efficient and economic alternative to the prior systems. For example, the present disclosure may be used to store and retrieve large and bulky items. At some scales i.e. where very large containers are utilised, it may be impractical to operate a cubic system.

### STATEMENT OF THE INVENTION Aspects of the invention are set out in the accompanying claims.

### System

A storage system is provided, wherein the storage system comprises: at least one storage floor comprising a track network, based on a grid system, the track network comprising a first set of track members extending in a first (x-) direction, and a second set of track members extending in a second (y-) direction, the second set of track members running transversely to the first set of track members in a substantially horizontal plane, wherein the track network comprises access aisles and storage aisles, wherein the storage aisles comprise one or more storage locations for receiving storage containers; and at least one load handling device operating on the track network for lifting and transporting storage containers. A storage location may comprise a support means for supporting a storage container.

Storage locations are arranged over a storage floor or level. Storage containers are positioned on support means within the storage floor or level. Support means may comprise one or more trestles, supports or brackets; optionally support means may comprise at least two trestles or supports or brackets. Typically, storage containers are stored in storage locations.

Storage containers are moved around the system by load handling devices or bots. The load handling devices may be semi-automated or fully automated. The trestles, brackets or supports are sized and arranged such that the load handling devices may pass between them, travelling on the network of tracks or track network. Further, the trestles are of a height such that when a storage container is supported by the trestles, an unloaded load handling device may pass under the storage container.

The track network is arranged with a number of access aisles, which are typically free of trestles, and a number of storage aisles which are equipped with trestles to provide locations for storage of the containers. Off the storage aisles, there may be a number of side-aisles for accessing further storage locations. The side-aisles of the storage aisles are one or more storage locations deep. Typically, side-aisles are between 2 and 6 storage locations deep; when the storage system is optimised for storage density. For storage systems optimised for fast and near uniform retrieval time the side aisles may be one deep. A plurality of storage aisles may be connected by access aisles located at each end of the storage aisles.

The track network, and accordingly storage locations, are arranged on a grid system to efficiently make use of the available space and typically to maximise the storage capacity of the system or facility. Each grid unit may be considered as a ‘reservable location’. A reservable location may be a single grid unit, or a reservable location may be a number of adjacent grid units, for example, a length of track or pathway. In some instances a reservable length of track may be a single unit, and in other instances some of the same unit tracks may be reservable, independently of each other. A reservation for a reservable location may have a start time and an end time. In this way, whether or not a grid unit is reserved will change over time. Reservable locations may be reserved for specific storage containers and or load handling devices. Every location within the system may be reservable. Over time, each reservable location may have several non-overlapping reservations which may be for the same or different load handling devices and or storage containers. Reservations for reservable locations may be held in a reservable location table. It will be appreciated that the load handling device navigation system and controller may support variable length reservable locations. In each variable length reservable location there may be at most one position where the load handling device can change its direction of travel to the orthogonal direction on the track network. In this way, locations of the grid system may be managed by a control facility, which will be described in more detail below.

Typically, tracks comprise troughs, rails, guideways or any other suitable structure for receiving or engaging with the wheels of a load handling device. Troughs, rails or guideways may be in pairs for each track pathway. The tracks provide pathways for the load handling device(s). It will be appreciated that some grid spaces may be without tracks to accommodate features of the building structure such as support columns which extend through the building and floor. The track network may be made up of any number of first and second members. The first and second track members are arranged substantially orthogonally, following a grid pattern. The floor is substantially flat and level and the tracks are arranged substantially in a horizontal plane.

Each location within the system may comprise a single grid unit, or locations may comprise an integer number of grid units. Tracks may be a single grid unit wide. Typically, each grid unit may comprise a track in an x-direction, and a track in a y-direction. Typically storage locations and other features of the system may comprise a single grid unit.

When being transported by a load handling device the storage container is supported by a support pad located on the upper surface of the load handling device. The support pad may be raised and lowered by the load handling device so that storage containers may be lifted clear of trestles arranged along the pathway of the load handling device, so that the trestles do not impede movement of the storage containers. Typically, load handling devices travel with the support pad lowered for stability. Typically, when a load handling device arrives at a location adjacent to the destination location (such as a storage location), the load handling device raises the support pad. The load handling device then moves into position to deposit the storage container. When the load handling device is in position between the trestles of the destination location, the support pad is lowered and the storage container is supported by a pair of trestles at each end. The load handling device can then move on from the storage location along the track network to carry out another load handling task. Typically, load handling devices travel between the storage aisles on the same floor by using the access aisles.

The track network may comprise one or more temporary storage locations comprising support means for supporting a storage container. The track network may further comprise one or more of: a charging bay; a passing lane; a siding; a lay-by; and or a passing point.

The layout of the floor, or track network, will typically comprise additional features for efficient operation of the system. For example, the access aisles may be two pairs of tracks wide. The inner pair of tracks (for example, closest to the storage aisles) provides the notional main pathway or highway for load handling device traffic. The outer pair of tracks (for example, furthest from the storage aisles) may provide the location(s) for other features of the network.

For example, lay-bys may be for automated recovery of failed or damaged load handling devices, or for operators to access load handling devices, or for placing failed load handling devices pending repair in situ or removal to the maintenance area. Passing points may allow for load handling devices travelling in the opposite directions on the same inner-track path to pass. Further, the track network may comprise locations for other ancillary functions for the system to operate.

Load handling device charging locations or charging points may comprise inductive charging pads arranged between the tracks that inductively transfer energy to a load handling device via interrelated charging pads on the underside of the load handling device. Typically load handling device charging locations may be located where load handling devices tend to spend a period of time. For example, a charging location may also comprise: a waiting location adjacent to a lift, for charging the load handling device while the load handling device waits for the next available lift-car to transfer to another level; locations at container receipt stations, locations at container dispatch stations, a queuing location for container induct stations, where the load handling device waits until a receipt station position becomes available; a queuing location for container dispatch stations, where the load handling device waits until a dispatch station position becomes available; or one or more locations along access aisles. It will be appreciated that there may be at least one charging location on each storage floor.

Adjacent tracks may be sized to allow two load handling devices, loaded with storage containers, to pass on adjacent tracks with sufficient space for adequate tolerances and to avoid collisions.

Temporary storage locations may be used for storage containers temporarily removed from a side-aisle to access storage containers deeper in the side-aisle. In use, for example, storage containers located in an aisle which are several storage locations deep may be moved to a temporary storage location in order to access a storage container that is located several grid units away from an access aisle.

If the load handling device is carrying a storage container these temporary storage locations can only be accessed when the load handling device's load pad is in the up state to avoid colliding with the trestles. Typically temporary storage locations would not be used at locations where load handling device through traffic is anticipated.

There may be specific aisles specially configured to provide physically and environmentally controlled storage conditions; which may be temperature and humidity control.

There may be specific aisles with a specific gaseous composition, for example reduced oxygen and enriched nitrogen atmosphere for fire risk reduction. Entire floors of the storage facility may operate with a reduced oxygen and enriched nitrogen atmosphere for fire risk reduction. The entire storage facility may operate with a reduced oxygen and enriched nitrogen atmosphere for fire risk reduction.

Aisles may be subdivided into one or more chambers or galleries, where each chamber is configured to provide different; physically and environmentally controlled storage conditions; which may be temperature and humidity control.

The floor may be divided by partitioning means into chambers, and the partitioning means have opening or hatches through which load handling devices may pass. The partitioning means may comprise a fire break means AND OR wherein the partitioning means provide segregation between user access and robotic access within the system.

Partitioning means may comprise partition walls. The storage aisles may be subdivided into chambers or galleries, for example. The partition walls may comprise environmentally controlling doors. This may allow each gallery or chamber to have its own unique target ambient air temperature, unique target ambient air humidity, for example.

The system may further comprise a fire detection system. The system may further comprise a fire suppression system, for example comprising a sprinkler system. The system may further comprise a smoke detection system. The system may further comprise a heat detection system. Each of the fire safety systems may comprise network connections to the control facility. Partitioning walls may provide the opportunity within dense storage areas to contain and or suppress the spread of fire.

The storage system may further comprise two or more vertically arranged floors, wherein floors are interconnected by a one or more lifts accessible from access aisles for transferring load handling devices between floors; and wherein floors comprise: at least one storage floor, and OPTIONALLY one or more sky-lobby floors for transferring between lifts.

The storage system may be extended to cover more than one floor. For example, the system may occupy several floors in a building. In order to achieve continuity between the floors or levels, the load handling devices or load handling devices may travel between different levels in specifically designed lifts. The lifts may transport the load handling devices with or without a storage containers on the load handling device's support pad.

In a multi-storey system, different floors may be reserved for different service levels. The floors with the shortest transit time to the storage system output stations may be reserved for storage of containers requiring the fastest access times. Whereas, the floors with the longest transit time to the storage system output stations may be reserved for storage of containers not requiring the fastest access times; or not paying a premium for the fastest access times.

Some aisles may be constructed with side-aisles a single storage location deep. These aisles may be reserved for storing containers requiring the fastest access times.

Each storey or floor may be served by one or more lifts. Typically, the lifts may be bi-directional lifts i.e. able to travel up or down. Lifts may be located directly or indirectly to access aisles. The floor or a lift-car may be have tracks to allow load handling devices to travel directly into the lift from the storage floor. Lift-cars may be sized to accommodate one load handling device loaded with a storage container, or lift-cars may be sized to accommodate more than one load handling device transporting storage containers.

Typically, there are at least two bi-directional lifts with access to each floor to provide resiliency in the case of a lift failure.

In some arrangements, lifts may be double-decked comprising stacked lift-cars, simultaneously serving adjacent floors and capable carrying two load handling devices, to produce higher lift throughputs. For the double-decked lift car the two load handling devices may be collected or deposited at different levels during the lift's travel, producing higher average lift throughputs.

Some levels or floors of a multi-storey system may comprise a sky-lobby, where load handling devices can transit on track pathways between lift systems. For systems without a sky-lobby the lift(s) may stop at each storage floor. In some systems, the lift(s) may stop at selected floors or levels. For example, some lifts may only serve lower floors in the system while other lifts sever upper floors. Or some lifts may be reserved for particular destinations. Typically, sky-lobby arrangements may be found in tall buildings where a single lift system is not feasible due structural limitations of tall buildings. For systems with one or more sky-lobby the lifts may provide access to a contiguous block of floors. In some systems there may be at least two sky-lobby floors providing access to the same levels in the building, to provide resilience to the system in the event of a load handling device failure blocking the reservable track locations at the entrance/exit of the lift-car at a particular level.

For very tall storage facilities, with many levels or floors, the vertical pathway between the lowest floor and the highest floor may require transit via several lifts or lift systems. Transfer from one lift system to another may be via transfer aisle pathway on a sky-lobby floor. Sky-lobby floors may be a storage floor as well as a floor for transferring between lift systems. Or sky-lobby floors may be solely a transfer floor.

It will be appreciated that levels or floors of the storage system do not necessarily need to correspond to the floors of a building within which the storage system is located. For example, several storage system floors may be located within a single story warehouse type building, having constructions within the space to create the storage system floors.

The storage system may further comprise one or more of: a control facility; environmental control facility means; safety systems; data collection means; data communication means; and communication systems.

Environmental control facilities may comprise global environmental control systems; or environmental control systems for storage floors or parts of floors. Control systems may control the temperature and or humidity of the air; and or the gaseous composition, for example, the nitrogen content of the air.

The storage facility may comprise one or more maintenance areas; on one or more floors. Maintenance areas may be accessible by an operator.

Maintenance areas may be arranged in voids between partition or bulkhead walls. Such voids may provide route for service feeds for example, cables and infrastructure for communication, power, lighting, environmental sensing, video camera, fire detection and fire suppression. Partitioning means may comprise temporary barriers to provide safe areas for technicians to work or for refuge.

Storage floors or aisles may be interleaved with maintenance areas. In other arrangements aisles may be arranged side-by-side or back-to-back, providing load handing devices to move directly between aisles (rather than via access aisles) on the track network, particularly, for example when travelling without carrying a growing tray.

Maintenance areas may comprise cable ways, for example, suspended from the ceiling. Cable ways may be used practically where growing floors are not interleaved with maintenance levels.

The storage system, may further comprise: one or more workstations, OPTIONALLY, wherein each workstation comprises a RFID reader, a scanner or a camera for reading an identity tag or label of the storage container.

The one or more workstations may be suitable for an operator, or the one or more workstations may be automated, or semi-automated. In this way, the storage system may be a goods-to-man system. Storage containers may be transported to or through workstations on a load handling device. The storage containers may remain on the load handling device while at a workstation, or the storage containers may be deposited by the load handling device on a pair or set of trestles at a workstation.

Workstations are for carrying out processes on storage containers. Workstations within the system may comprise one or more of: a container induct workstation; a container dispatch workstation; a pick workstation, for picking articles or items from containers and transferring these to another container, or for transferring items to a delivery container; a work station for returning empty storage containers to the container induct.

One or more specific workstations may be combined into a single work station. For example combined work stations may comprise: a combined induct and dispatch work station where different tasks or functions can be carried out at the same workstation.

Each workstation may have the capability to read the storage container's identity tag or label prior to processing the storage container. In this way the controller can confirm the correct the storage container is being handled at each stage; and take corrective action if the correct the storage container is not being processed at any stage.

Within the storage system, different types of work station may be located on a single floor or within a specific area of a floor, or work stations may be distributed on growing floors and or sky lobby floors.

The storage system may comprise ancillary functions.

It will be appreciated that the storage system may further comprise ancillary spaces and ancillary functionality. For example, the storage system may machine-to-person workstations, and load handling device service and maintenance stations.

A storage container may comprise a standard shipping container. Alternatively a storage container may comprise a large area tray, onto which items are placed. A storage container may comprising a unique identity tag or label.

Each storage container may have an RFID tag or marker such as a barcode or QR code that can be read with a scanner or camera providing a unique identity tag or label. Interrelatedly, the load handling devices or load handling devices of the system may have a RFID reader or a scanner or camera capable of reading the lag or label of growing trays. Similarly, workstations, used for processing growing trays, may have an interrelated a RFID reader or a scanner or camera capable of reading the lag or label of growing trays. Thus, the load handling devices have the capability to read the growing tray's tag or label during the operation to pick up the growing tray from a trestle. Similarly each growing tray processing workstation has the capacity to reading the growing tray's tag or label. Each growing tray processing workstation may read the growing tray's tag or label prior to processing the growing tray. In this way the controller can confirm the correct growing tray is being handled at each stage, and may take corrective action if necessary if it is not the correct growing tray at any stage. Advantageously, the system may have enhanced confidence in the integrity of the control, and may allow audit records to be created.

### Load Handling Device

A load handling device for operating in a storage system is provided. A floor of the storage system may comprise a network of tracks, or track network, based on a grid system, the tracks comprising a first set of track members extending in a first (x-) direction, and a second set of track members extending in a second (y-) direction, the second set of track members running transversely to the first set of track members in a substantially horizontal plane, the load handling device may comprise: a first set of wheels for engaging with the set of track members in the first direction, and a second set of wheels for engaging with the set of track members in the a second direction, wherein the load handling device is driveable in first or second direction to any location on the track network; and a support pad for carrying a storage container.

The support pad may be raised and or lowered in a vertical (z-) direction.

Load handling devices may also be known as bots, automated vehicles or semi-automated vehicles. In this way a load handling device may be used to lift storage containers and transport storage containers along the network of tracks to any location in the storage system, such as storage locations or workstations. The bot or load handing device may be capable of moving in forward and reverse direction along the x- and y-direction tracks.

Typically, storage containers may be placed onto support means, such as trestles by a load handling device. When a load handling device carrying a storage container is in position, the support pad is lowered so that the trestles support the storage container. The load handling device may then move underneath the storage container, away from the location (without continuing to carry the storage container) along the tracks on to a subsequent lifting and or transporting task.

To lift a storage containers from a storage or other position, with the support pad in a lowered position, the load handling device positions itself beneath the storage container and raises the support pad such that the load handing device supports the storage container and may transport the storage container to an alternative location.

The support pad or vertical lift mechanism may comprise an electromechanical mechanism. The vertical lift mechanism may comprise an electric hydraulic generator and one or more hydraulic ram(s). A protective enclosure may be used to prevent hydraulic fluid contaminating the storage system in the event of a failure and leak. The electric hydraulic generator and ram components may be commercially available components.

The first set of wheels and or the second set of wheels may comprise two or more wheels on each side. The load handling device may comprise a suspension means for one or more of the wheels. It will be appreciated that while the floor of the storage facility may be substantially flat so that the tracks are in a substantially horizontal plane, it may not be cost effective to ensure that the floor is completely flat. In any event, the floor may have step changes in level or be uneven. The track pathways may be defined by the navigation means of the load handling device, interacting with the control facility, or the track pathways may be defined by grooves or rails as noted herein elsewhere. An arrangement of three wheels on each side of the load handling device may allow the device to be tolerant to step changes in track height—either intentional changes in track height or due to imperfections in the construction of the facility floor. When moving on the first set of wheels or second set of wheels over a step change, the load handling device will rotate as the centre of gravity of the load handling device passes over the discontinuity in level, or step. In this way, the load handling device typically keep at least four of the wheels in contact with the surface or track.

Each set of wheels may be located on their respective sides with one wheel substantially at the centre of the side to allow the load handling device to remain substantially stable or tolerant of level changes or steps in the track. For example, when the set of wheels comprises three wheels, the middle wheel may be located substantially at the centre of the side.

Further, by providing a suspension to the wheels, the load handling device may be more tolerant to changes in the track as the load handling device moves along a pathway. All of the wheels may be provided with suspension means. Changes in the track may comprise small changes in direction as well as step changes.

The wheels may be aligned in the first (x-) direction or aligned in the second (y-) direction and the wheels comprise caster wheels.

The wheels may be aligned in x- and y-axis directions of the load handling device, corresponding to the direction of the track member layout in the grid based network of tracks. Where the wheels comprise caster wheels i.e. able to deflect slightly by a relatively small angle centred on the mounted direction, the load handling device may be more tolerant to misalignment between track members or sections of track. The degree of caster may be limited. The caster functionality may be enabled by a spring arrangement. The wheels may be spring-loaded to be in alignment to the load handling device axis. The wheels may have some mechanically limited flexibility to help the load handling device negotiate track imperfections.

The features above are designed and engineered to provide less restrictive requirements on step changes, gradients and alignment of tracks over a two wheel per side vehicle; and allow less restrictive build tolerances. This allows repurposing of old warehouse buildings and reduced tolerance on the construction of new-build buildings.

It will be appreciated that the load handling device may comprise a direction change mechanism for switching between engagement of x-direction wheels and y-direction wheels being engaged with the track.

The direction change mechanism and the storage container lift mechanism may be the same mechanism.

The x-direction wheels may be mounted on a sub-chassis which moves vertically supported within a retaining flange at each end. Vertical movement of the sub-chassis in retaining flange may be made to have low friction by use of roller bearings, needle bearings, slide bearings, or bearings. In one arrangement, the vertical movement of the sub-chassis may be achieved with a two-stage hydraulic ram. It will be appreciated that the hydraulic ram may comprise additional stages. The y-direction wheels may be similarly mounted. It will be appreciated that having the y-direction wheels mounted directly to the main chassis with suspension units, and the x-direction wheels moving relative to the main chassis may be advantageous.

In alternative arrangement, vertical movement of the sub-chassis may be achieved by a toothed rack in a retaining flange. The toothed rack may be driven by a toothed pinion drive wheel by an electric motor. The wheel sub-chassis arrangement may comprise a toothed rack assembly at each end. Each sub-chassis may comprise one or more sensors for detecting and reporting the relative vertical displacement between the sub-chassis and the support pad or storage container carrying chassis.

The load handling device may further comprise a re-chargeable battery and or super capacitor for powering a drive motor, wherein the re-chargeable battery and or super capacitor is charged through inductive charging pads positioned on the underside of the load handling device.

The load handling device may be driven by an on-board motor, which is powered by the re-chargeable battery. In an alternative arrangement, the on-board motor may be powered by a super capacitor. Or in some arrangements, the load handling device may comprise both a re-chargeable battery and a super capacitor. It will be appreciated that super capacitor charging (and discharge) times may be much faster compared with battery recharging times. Accordingly, where both rechargeable batteries and super capacitors are used, the load handling device may benefit from quick increases or top-ups of power from the super capacitor, and more sustained power from the rechargeable batteries.

Charging locations may be conveniently located where load handling devices tend to remain for a period of time but may be anywhere on the track network. Typically, energy providing inductive pads are located between the track rails at specific grid locations.

One or more of the wheels may be drivable.

All the wheels of the first set of wheels and the second set of wheels may be drivable.

Each of the wheels of the sets of wheels may be driven. In this way, if one of the wheels loses contact with the track surface, the load handling device will still be driven by the remaining wheels. Again, this may assist in maintaining stability of the load handling device over uneven surfaces.

One or more of the first set of wheels and the second set of wheels are lockable by locking means.

The locking means may comprise an electromechanical lock for locking the drive motors for x direction travel and or y direction travel. When the load handling device is in a parked position, for example, when lifting or depositing storage containers, when travelling in a lift car, or when in a charging location, the motors may be locked to prevent wheel movement and travel of the load handling device. The electromechanical lock may have releasing means. For example, the releasing means may be a switch, operable by the control system or a technician. When the lock is not applied, the wheels may be able to freely rotate. In this way, if the load handling device fails, the lock may be released and the load handling device may be simply pushed or pulled to a maintenance area. The lock may be releasable by a recover device. A recovery device may further be able to push or pull a failed load handling device once the load handling device is able to free-wheel. A recovery device may move a broken down load handing device into a maintenance area, so as not to put technicians at risk if they were to work in other areas of the system.

The load handling device may further comprise: a RFID reader; a scanner; and or camera, for reading an identify tag or label.

The load handling device may have the ability to read identity tags. For example, during operation, the load handling device may able to identify specific storage containers. Or the load handling device may be able to identify specific locations within the system, where tags have been placed in or along tracks, or at workstations.

The load handling device and a supported storage container have a footprint that occupies only a single grid space in the storage system.

A single grid space, or grid unit, may be a single reservable location. In this way, load handling devices, carrying storage containers may traverse any track pathway, substantially without the risk of collision (assuming that the load handling device is centred on a grid location and the storage container is properly centred on the support pad of the load handling device).

The load handling device may further comprising navigation means for monitoring and controlling motion along the track network. The load handling device may further comprise a communication means for receiving instructions from a central control facility and for transmitting data. The load handling device may further comprise a proximity sensor.

The load handling device may have a software map in non-volatile memory of each floor of the storage system. The software map may contain information about each of the reservable track locations, comprising the physical dimensions, the identity codes of fiducial markers, the position of fiducial markers, physical attributes of the reservable track location for example the presence of trestles, and the topology of the track pathway connections between reservable track locations. The software map may allow the device controller to compute the parameters of the trajectory for each segment of the path provided by the (central) control facility.

The device controller may control the servomechanisms and electric motors that select the wheel state, support pad state, and cause the load handling device to move along the track. The load handling device may acknowledge all instructions it receives with a reply message transmitted to the controller.

At least some navigation and other control instructions for the load handling device are provided to the load handling device by the (central) control facility.

The (central) control facility may provide instructions for a path for the load handling device to travel along, across a floor. The path is planned by a path planning module. A segment of the path at a specific time may be reserved, issued as instructions to the load handling device and logged in advance of a start time. Route instructions to traverse individual segments of the path or track are issued to the load handing device and to a clearance module of the control facility.

It will be understood that the path planning module plans a collision risk free path, in advance of the load handling device moving. Meanwhile, the path clearance module monitors the position, velocity and status reports from all load handling devices operating within the storage system to ensure that the intended planned path for a specific load handling device remains free of collision risk. Planned paths may become compromised and risk collision or another form of accident by: a load handling device failure, underperformance of a load handling device, and or communication failure to or from a load handling device. Where a collision risk is identified, the path clearance module may advise the path planning module so that a new collision-risk-free path may be planned.

The load handling device itself may comprise a device controller. The device controller may receive and acknowledge instructions from the central control facility. Further, the device controller may use outputs from the load handing device sensing means for feedback to use in controlling the movement of the load handling device, and for feedback or reports to provide to the central control facility, particularly the clearance module.

As mentioned above, it will be appreciated that the load handling device may comprise sensing means. Sensors may be one or more of: a laser scanner, a scanner, or a camera, for detecting a fiducial marker in proximity of the tracks; a depth sensor or camera for detecting the track member crossings; sensors for monitoring and reporting the rotation of one or more of the wheels; and a non-driven wheel detector for monitoring and reporting the rotation of the wheel. It will be appreciated that other sensors and data collectors for monitoring the condition of the load handling device may be provided. The load handling device may transmit a position and status report to the central controller (control facility) each time it passes a fiducial marker.

A load handling device may further comprise a proximity sensor, and preferably a proximity sensor on each side of the device, for warning of unexpected collision risks. In such a situation, a warming may trigger an emergency stop. Examples of unexpected articles posing collision risks may comprise other load handling devices directly in the intended path; accidentally dropped storage containers in the intended path; crash barriers marking the end of a path and encountered because of navigational error or mapping error; trestles encountered because of navigational error or mapping error; and (human) operatives working within the facility.

The system may further comprise a survey bot for collecting data and monitoring the condition of the system. The movement and control of the survey bots may be similar to that of the load handling devices. The survey bot may travel along growing aisles and survey each storage container. For example, the survey bot may be a vehicle similar to the load handling device but without a support pad and with a sensor pack.

Other types of bots or mobile devices operating within the system and cooperating with the devices described are anticipated. For example, task specific devices.

### Control Facility

A control facility is provided for controlling and operating a storage system as discussed above. The control facility comprises one or more of: an environment control module; a manager module; a task planner; a bot path planning module; a bot path clearance module; a communications module; a lift task planner; a bot charge state manager; a data storage and persistence module; a long term data storage module for providing data to machine learning algorithms; a recovery, repair and or maintenance manager module to modify plans and schedules to facilitate recovery, repair and maintenance operations; and a machine learning and or artificial intelligence module designed to fine tune the system based on its previous operational history.

One or more of: air temperature, independently for one or more storage aisles, chambers or floors; air humidity, independently for one or more aisles, chambers or floors; air flow, independently for one or more aisles, chambers or growing floors; may be controllable by the control facility, AND OR the control facility may carry out planning and or management; the control facility may confirm the correct storage container is being handled at each stage; the control facility may collate data from monitoring station(s); AND OR the control facility may create audit records of each operation.

The control facility may comprise one or more computers. The one or more computers may be physically co-located with the farming system, or the one or more computers may be located remotely from the farming system. The control facility may be accessed via internet and or based in cloud services. A central control facility may be responsible for managing the farming system. Individual components of the system, such as the load handling devices or bots, managing stations may comprise local or individual control facilities which communicate with the central control facility. It will be appreciated that the central control facility may coordinate the control systems of individual components within the farming system. Individual components within the farming system may operate autonomously or semi-autonomously to at least some extent.

The one or more computers may comprise: one or more memories and one or more processors, wherein the one or more memories comprise program instructions executable by the one or more computers to implement the control facility for a storage facility. The system or control facility may comprise a plurality of processing components (modules), each configured to perform a respective portion of control system which is configured to have at least one module.

The control facility may comprise any suitable architecture. Software modules of the control facility may be implemented to run on many computers located in several different physical locations within the system, or remotely from the system via a cloud based system for example. Each software module may be responsible for the maintenance of its own data structures and the persistence of those data structures to non-volatile storage mediums or devices.

Data may be exposed and transferred between modules by any suitable means. For example, comprising calls to interfaces designed to exchange data and messaging protocols designed to exchange data.

The software modules may be continuously running in parallel.

State changes in the software may effect downstream modules. State changes may occur immediately on notification of the previous module. Typically, a state change may result in a downstream entry of a task in a task queue, or completion of a task may result in a state change.

The environment control module may control the environment within the storage system. The environment control may be on a global scale/facility wide, or the environment control may be localised to a storage aisles, sections of storage aisles, or chambers. The environment control module may control temperature, and air-flow.

The system planner or manager module identifies demand for specific multiple storage containers at specific time slots such that fungible groups of storage containers can be created and allocated to adjacent storage locations in a side-aisle. This may be a highly efficient optimization as no temporary relocation of storage containers will be required to access members of the fungible group because the storage container nearest the centre of the aisle can be accessed first.

The task planner module evaluates the expected time of a storage container at a storage location before retrieval, and executes an optimisation algorithm to place the shortest storage duration storage containers in the aisles closest to dispatch workstations the floors with the harvesting equipment thus minimising the total lift service time required and hence minimising the number of moves required.

The task planner module processes and builds a plan. The plans created by the task planner are continually modified as the demand forecast develops. The task planner may modify the plan to meet demand at specific time slots. The tasks are created and planned with a task planning horizon time limit.

The storage system bot or load handling device path planning module, for planning route to be taken by load handling devices, may reserve the overshoot reservable track location for the estimated settling time of load handling device lateral control systems for each segment of the path. Where a segment of path is defined as from a reservable location that the load handling device starts moving from to the reservable location where the load handling device is planned to next come to rest, this include the transient stop as the load handling device changes the wheel configuration between x and y or y and x.

The path planning module reserves reservable locations along the tracks for specific storage container move tasks. A separate instance of the load handling device path planning module may run for each floor. The load handling device path planning module creates reservation tables for all reservable locations on the entire floor. Each reservable location may have many reservations for different load handling devices at different time periods. As collisions between large load handling devices may require extremely lengthy recovery procedures, the load handling device path planning module may reserve the overshoot reservable location for the estimated settling time of load handling device lateral control systems; to further minimise the risk of load handling device to load handling device collision. The load handling device path planning module identifies and evaluates these potential routes as part of its default behaviour. In some instances, where load handling devices are not carrying a storage container, it may be possible to plan routes beneath storage locations.

The load handling device or bot path clearance module, for ensuring that the planned route will be clear for a load handling device to follow, creates records of occupancy of each reservable location by load handling devices, and records of reservable locations load handling devices have been given clearance to enter as they traverse each reservable location on their planned paths between storage container pick-up and storage container deposit. Typically load handling devices report their position entering a reservable location, centred on a reservable location and leaving a reservable location. The load handling device clearance module is necessary to prevent collisions between load handling devices as a result of electromechanical failures of one or both load handling devices, communication failures with one or both load handling devices, failures of load handling devices to maintain the assumed kinematic and physical profile.

The load handling device selection and path planning module may be responsible for selecting an available bot to carry out a lifting and or transporting task.

The communications module may be responsible for communications between other modules and managers. Each component of the storage facility may comprise a communications module. Each load handling device or bot may comprise a communications module. Each lift may comprise a communications module. Each workstation may comprise a communications module.

A lift task planner module creates the sequence of lift-car stops. In the preferred embodiment the lift task planner module selects lift operations to maintain the sequence of load handling device moves with the priority as determined by the task planner module, but whenever queues form the lift task planner module switches the pick-up and drop-off planning to maximise lift throughput. In the case of a double deck lift-car this would mean delaying certain pick-ups to create concurrent pick-up and drop-off operations on adjacent floors.

The recovery, repair and maintenance manager module auto triages system failures including, but not limited to:
1. Load handling device failures, typically the module sets flags in the data to specify the reservable locations failed load handling devices occupy are excluded; and sets flags in the data to specify that any inaccessible storage containers as inaccessible; and any failed load handling devices are un-taskable i.e. unsuitable to be assigned tasks. The module will request the path planning module to run and its algorithm looks for and plans alternative routes avoiding the newly excluded reservable locations. Any tasks which are not plannable because of multiple failures are flagged to human management, who can choose to bring maintenance and recovery missions forwards.
2. Lift failures, typically the module sets flags in the data to specify the lift is out of service; and sets flags in the data to specify that any stranded load handling devices are un-taskable and any inaccessible storage containers (on a stranded load handling device) are flagged as inaccessible. The module will request the lift task planner module to re-plan all outstanding lift tasks.

The recovery, repair and maintenance manager module can also be used to configure the storage facility for human recovery, human repair and human maintenance operations. For example a manual recovery of a failed bot or load handling device may be achieved with all load handling devices on a floor either safety stopped or moved to other floors; and then safety barriers placed across the tracks to physically prevent load handling devices coming in conflict with humans. The recovery, repair and maintenance manager module would also set flags in the data to exclude all the isolated track; so that normal production could resume on the non-isolated section of the floor. Once the recovery is completed, all load handling devices on the floor would be stopped or moved to another floor. The physical safety barriers would be removed, the flags set in the data to exclude all the isolated tracks would be cleared. The load handling device path planning module would then be able to use all non-excluded reservable locations when planning load handling device paths as load handling device activity resumed on the floor.

The machine learning and or artificial intelligence module is designed to enhance planning and productivity and fine tune the system based on its previous operational history. The module may use machine learning and artificial intelligence techniques in at least the following ways:
1. Analysing long term data for load handling device moves, and aggregating over the different classes (models) of load handling devices to refine the parameters used to define the physics models used in path planning.
2. The identification of possible load handling device routes on a floor, and the optimization of the routes selected.
3. Analysing long term data for lift moves, and aggregating over the different classes (models) of lifts to refine the parameters used to define the physics models used in lift planning.

The machine learning and or artificial intelligence module may use, but is not limited to, the following Artificial Intelligence and Machine Learning techniques:

| | |
|---|---|
| 1. | Machine learning |
| 2. | Neural networks |
| 3. | Machine learning (general) |
| 4. | Supervised learning |
| 5. | Probabilistic graphical models |
| 6. | Support vector machines |
| 7. | Bio-inspired approaches (including, but not limited to ant colony |
| | optimisation) |
| 8. | Classification and regression trees |
| 9. | Deep learning |
| 10. | Rule learning |
| 11. | Unsupervised learning |
| 12. | Reinforcement learning |
| 13. | Instance-based learning |
| 14. | Latent representation |
| 15. | Multi-task learning |
| 16. | Logical and relational learning |
| 17. | Logic programming |
| 18. | Expert systems |
| 19. | Description logics |
| 20. | Logic programming (general) |
| 21. | Fuzzy logic |
| 22. | Ontology engineering |
| 23. | Probabilistic reasoning |

It will be appreciated that the track and load handling devices are arranged such that when a load handling device is positioned at a fiducial marker marking the notional “center” of a reservable location the load handling device may be free from collision risk with other load handling devices whether stationary or moving in adjacent locations.

It will be appreciated that alignment of the load handling device for direction change to the orthogonal direction on the grid based track network is achieved using a laser scanner, a scanner, or a camera on the load handling device and a fiducial marker in proximity of the tracks marking the position of the intersection of the orthogonal tracks in the reservable location. This arrangement may provide accurate positioning of the load handling devices wheels with the tracks in the orthogonal direction.

It will be appreciated that alignment of the load handling device within the storage location is achieved using a scanner, a laser scanner, or a camera on the load handling device and a fiducial marker or markers in proximity of the tracks marking the notional “center” point of the reservable location. This provides accurate positioning of the storage container relative to trestle.

The load handling devices navigational system for tracking and controlling motion along the orthogonal or grid based track structure is achieved by using sensor information.

In use for load handling device or load handling device operation in the facility, a detailed map of each floor is downloaded to each load handling device. The data associated with the map provides the load handling device's motion control system with sufficient data to compute its trajectory and control its motion along the trajectory. The data included with the map includes, but is not limited to, the physical dimensions of the reservable location, the positions of the fiducial markers on the reservable location, the connections between the reservable location and any adjacent reservable locations.

The instructions for the load handling device to move are generated by the controller's load handling device path clearance module; and transmitted by the controller's communications module to/from the load handling device. The instructions for the load handling device to move have a start time for the move; and are transmitted to the load handling device in advance of the start time. The load handling device may transmit confirmation that the instructions are received. This protocol allows the move instruction to be transmitted several times if required and adds resiliency to the communications; because 100% message delivery is not guaranteed or expected.

Alignment of the load handling device for direction change to the orthogonal direction may be achieved using a laser scanner, a scanner, or a camera on the load handling device and a fiducial marker in proximity of the tracks marking the point. This provides accurate positioning of the load handling devices wheels with the tracks in the orthogonal direction. For reservable locations where change to the orthogonal direction is not permitted the fiducial marker may be placed at the notional centre point of the reservable location.

Alignment of the load handling device within the storage location may be achieved using a scanner, a laser scanner, or a camera on the load handling device and a fiducial marker or markers in proximity of the tracks marking the reservable location centre point. This provides accurate positioning of the storage container relative to the trestle.

### Use

A method of using a storage system to is provided. The method may comprise one or more steps of: transporting and depositing storage containers using a load handling; depositing a storage container in a storage location; retrieving a storage container from a storage location; arranging storage containers in storage aisles; optionally controlling the environment in the storage aisles according to the requirements.

If a load handling device is instructed to deposit a storage container on a pair of trestle in a storage location by the central control facility, while carrying the storage container, the load handling device travels along an access aisle until the load handling device is adjacent to the desired storage location. With the support pad raised, the load handling device moves into a side-aisle from a storage aisle such that the storage container on the support pad is above the trestles in the side-aisle. It will be appreciated that the pathway into the storage aisle will be calculated or planned by the control facility to avoid storage locations where storage container are resting on trestles. Typically, the load handling device may be instructed to deposit the storage container in a storage location so as not to obstruct access to other available storage locations in the storage aisle. When in position at the instructed location, the load handling device then lowers the support pad, leaving the storage container supported by the trestle in the storage location. The load handling device then moves in the reverse direction, or via another instructed route, to return itself to an access aisle.

If a load handling device is instructed to retrieve a storage container on a pair of trestles from a storage location by the central control facility, the load handling device travels along an access aisle until the load handling device is adjacent to the side-aisle containing the storage location containing the specific storage container. With the support pad lowered, the load handling device moves into the side-aisle until the support pad is positioned below the target storage container. The load handling device then raises the support pad, lifting the storage container above the trestles. Carrying the storage container, the load handling device then moves in reverse through the storage area, with the support pad in the raised position to avoid colliding with trestles, to the access aisle. Once on an access aisle track, the load handling device may lower the support pad before navigating to its next destination.

It will be appreciated that where the central control system is aware there are multiple identical storage container of the same item, then the control facility may exploit the fungible nature of the group of storage containers, and place the fungible storage containers in the same storage aisle. When any of the storage containers of the fungible group are required the controller planning module selects the storage container in the fungible group closest to the access aisle. That is, the control facility selects a storage container that can be accessed without temporarily relocating the other storage containers in the storage aisle.

The number of load handling devices required by the system may be determined by the number of storage container moves, rather than the number of aisles and or storage locations, or the number of floors.

It will be appreciated that storage containers are not stacked. Accordingly, the storage system and retrieval system may accommodate containers which are not possible to stack, or containers which have variable height top, or uneven upper surface.

In this way, the present invention addresses some of the problems of the prior art and provides a system, method and devices for article storage and retrieval systems.

### Integration with Other Systems

The storage and retrieval system and growing facility may be integrated with other automated systems. The integration may comprise:
Conveyors transporting totes or containers containing retrieved or picked the goods inwards or inbound mechanical handling equipment of the grocery customer fulfilment centre. In some arrangements, the dispatching workstations may be designed to be compatible with the totes used within the automated grocery customer fulfilment centre, and particularly the goods inwards mechanical handling equipment and system.
Autonomous airborne vehicles or drones transporting totes
Autonomous terrestrial vehicles or autonomous guided vehicles transporting totes
Any form of human operated goods vehicles transporting totes
Any form of magnetic levitation transportation system for transporting totes
Any form of integration between the automated grocery customer fulfilment centre's order management and order forecasting systems and the storage system's planner/manager module. In particular where such integration is used to ensure product availability to the automated grocery customer fulfilment centre at specific time slots.

Embodiments of the present invention will now be described, by way of example only, with reference to the accompanying drawings, in which like reference numerals are used for like features, and in which:

FIG. 1 is a representative drawing of a prior art storage system;

FIG. 2 is a representative drawing of a prior art storage system track arrangement;

FIG. 3a is a representative drawing of a prior art storage system load handling device;

FIGS. 3b and 3c are representative drawings of a prior art storage system load handling device with storage container;

FIG. 4 is a representative drawing of a prior art storage system with the load handling devices on a grid above the storage;

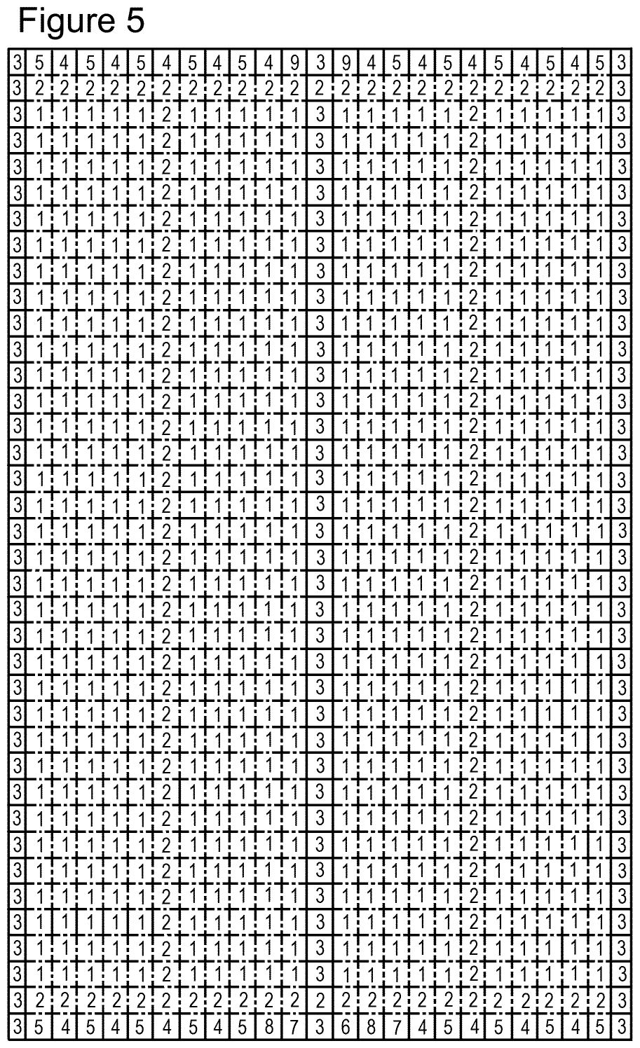

FIG. 5 illustrates the floor plan of the storage facility.

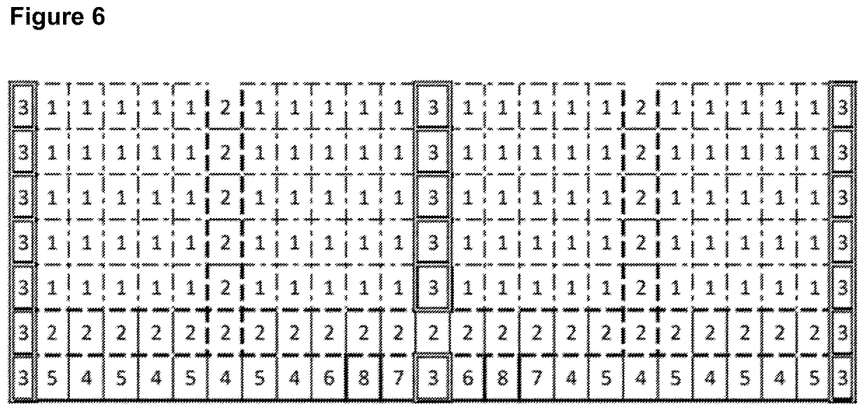

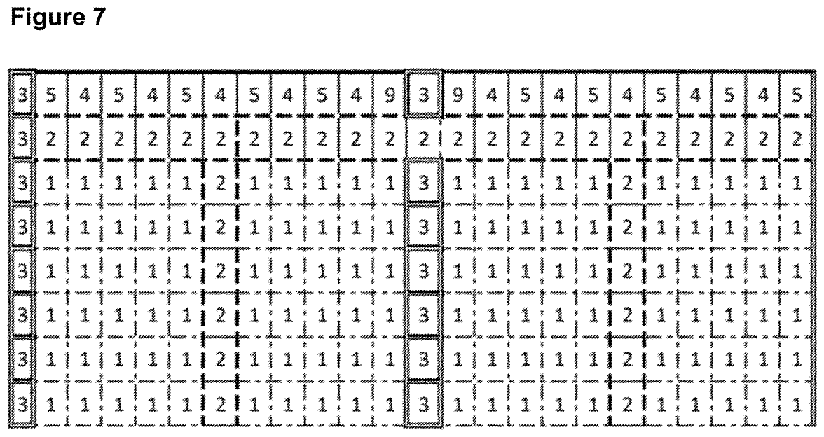

FIGS. 6 and 7 illustrate a portion of the storage floor shown in FIG. 5;

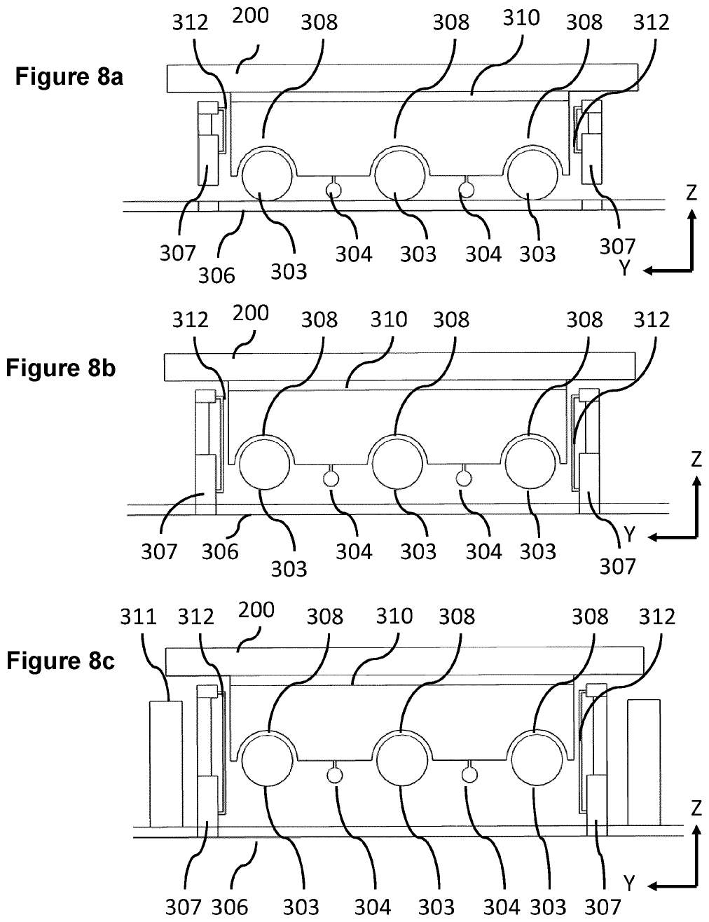

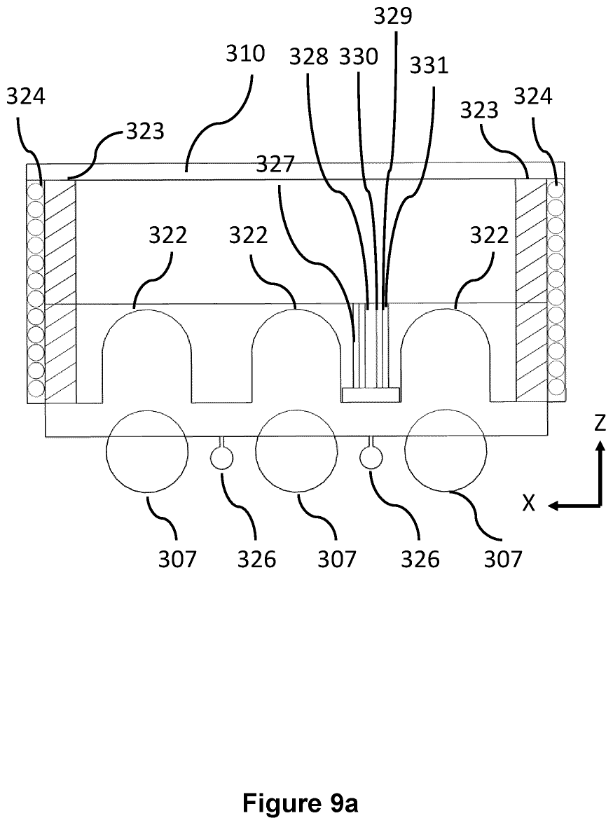

FIGS. 8 a-c illustrates a plan view of a long side, or y-z side, of a load handling device, with a storage container resting on the lifting pad;

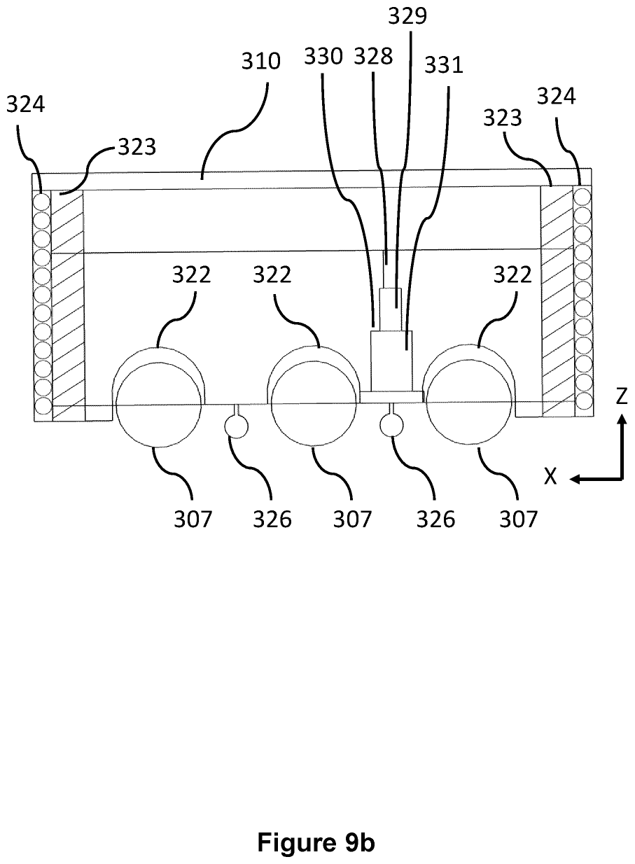

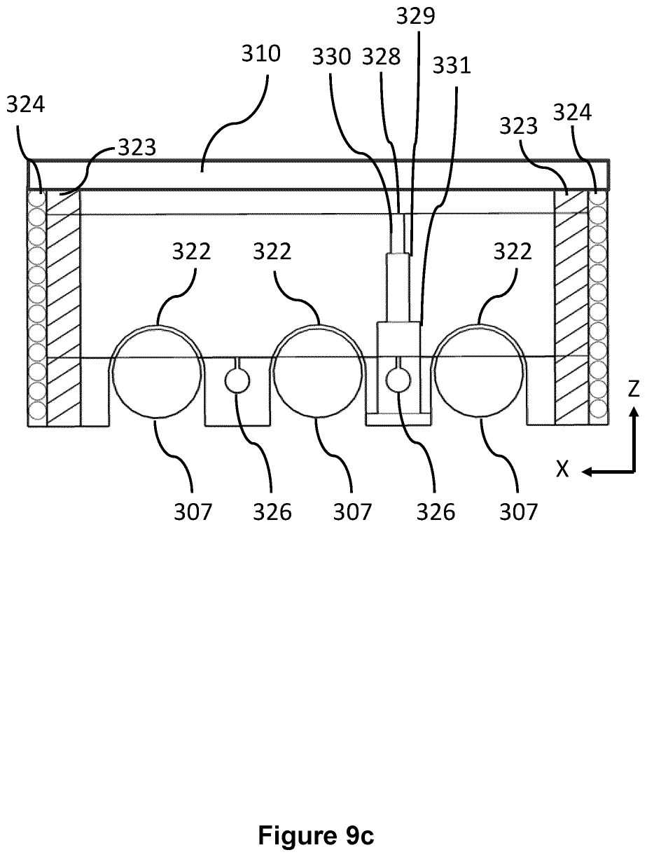

FIGS. 9 a-c illustrates an elevation view of the short side, or x-z side, of the load handing device without a storage container and detailing the lifting pad;

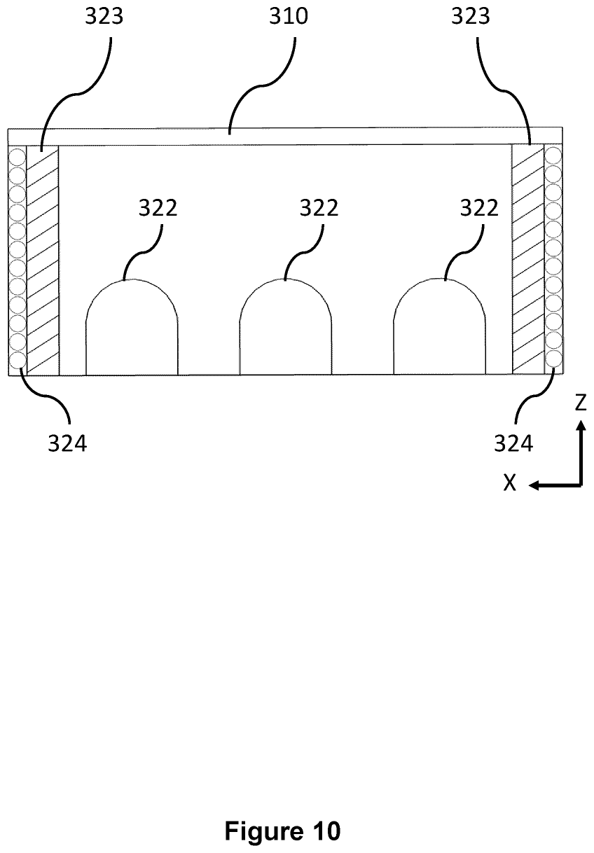

FIG. 10 illustrates an elevation view of a short side, or x-z side, of a sub-chassis of the load handing device with the retaining flange removed;

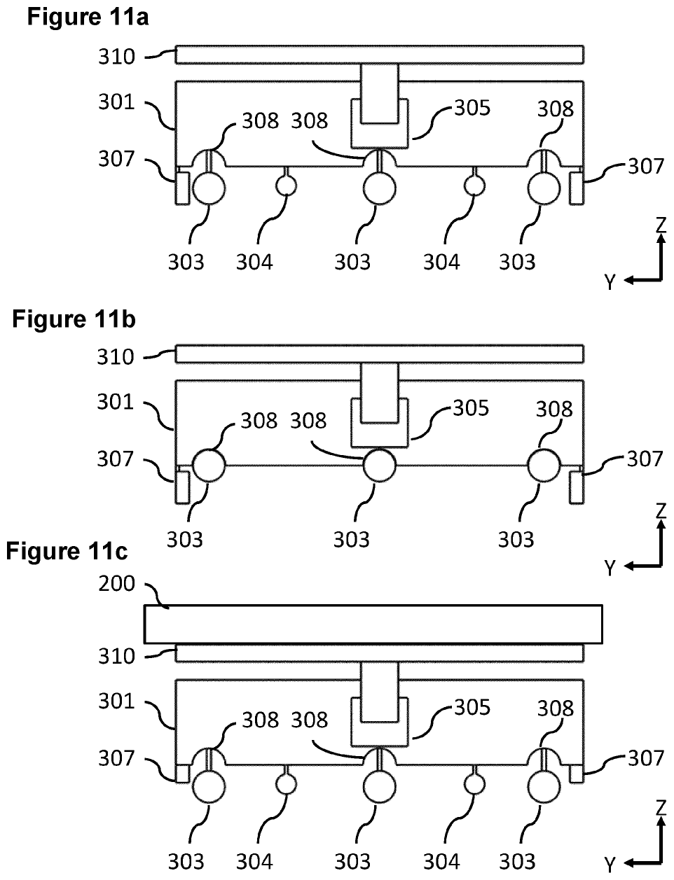

FIGS. 11 a-c illustrates an elevation view of the long side, or y-z side, of the load handling device;

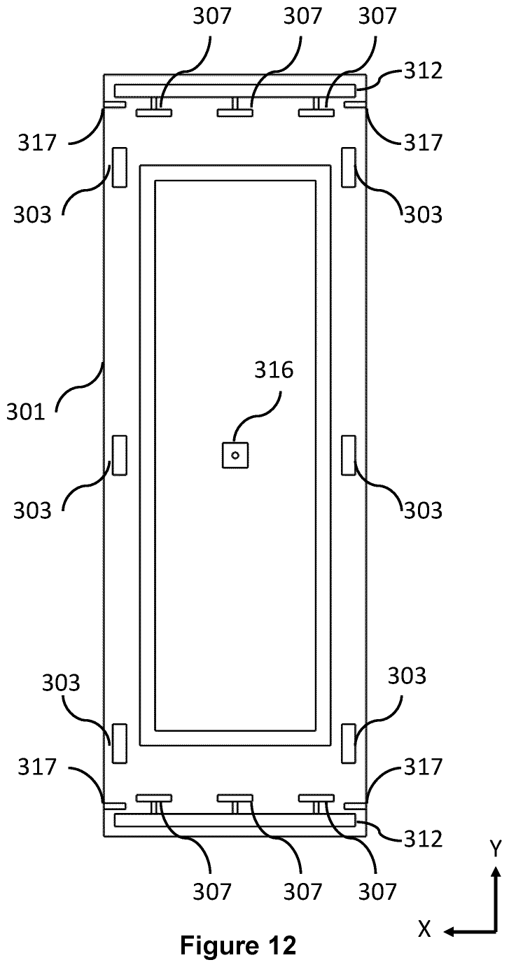

FIG. 12 illustrates a plan view of the underside, x-y, of the load handling device;

FIG. 13 is a schematic diagram of a controller for the storage system.

### DETAILED DESCRIPTION OF DRAWINGS

The present invention may form part of a larger system. It will be appreciated that the system, methods and devices described herein are exemplary only, and other combinations and configurations of the apparatus and equipment described are anticipated by the inventors of the present disclosure without departing from the scope of the invention described here.

As noted above, FIGS. 1 to 4 are representative drawings of prior art storage systems.

The storage system, load handling devices, storage locations, methods of use and control facilities of the present invention are illustrated in the remaining drawings.

FIGS. 5-7 show schematic drawings of a storage floor. The storage floor is divided into a grid of units where each unit has a designated function. Aisles 2 are arranged across the width and length of the storage floor. Typically, access aisles 2 are two units wide and arranged across each end of the storage floor as shown in FIG. 3. Between the ends, the access aisles 2 are joined by storage aisles 2 running perpendicularly to the access aisles 2 and along the length of the storage floor. The storage aisles 2 are typically one unit wide. Adjacent to the storage aisles 2 are storage locations 1. The storage locations 1 may be accessed by load handling devices from either the access aisles 2 or the storage aisles 2.

As noted above, each storage location 1 is provided with trestles for supporting storage containers. When a load handling device is not transporting a storage container, the load handling device is able to move in x- and y-directions to any storage floor aisle or storage location, via any accessible route. However, the load handling device is able to move in one direction (x) through the storage locations, any attempt to traverse the storage location in the orthogonal direction could result in a collision between the load handling device and the support trestles.

As illustrated in FIG. 5, a maintenance area 3 is located through the centre of the designated storage location 1 area of the floor. Further maintenance areas 3 are located along the long sides of the floor and at some unit locations along the short sides of the storage floor. The short sides of the storage floor also provide grid unit locations for lay-bys, temporary storage, lift ingress positions, lift egress positions, lift shafts, and charging points. These maintenance areas 3 are not accessible by load handler devices and are not used for the repair of load hander devices.

FIGS. 6 and 7 show, in more detail, a portion of the storage floor as illustrated in FIG. 5.

FIG. 6 illustrates an end of the storage floor comprising two lift. As illustrated, the end row of the storage floor comprises two lift shafts 8. Adjacent to each lift shaft 8, on a first side is a lift ingress position 6 and a lift egress position 7. The lift ingress 6 and lift egress 7 are kept clear so that load handling devices may enter and leave the storage floor to be transported to other floors within the system. Between the lift areas, there is an additional maintenance area 3. The remainder of the unit locations along the end row of the storage floor alternative between lay-bys 4 and temporary storage locations 5 which may be used during operation of the system. Typically lay-bys 4 are used to allow load handling devices, unloaded or loaded with storage containers to pass when the aisles are congested. Lay-bys 4 may also be used to temporally locate malfunctioning load handing devices. Temporary storage locations 5 will typically comprise a pair of trestles. In this way, storage containers may be temporary placed on trestles while they await further transportation to other locations. It will be appreciated, that the temporary storage locations 5 are located relatively close to the lift shafts 8 so that they may be used as a waiting area for transportation between floors in the system. Temporary storage locations 5 may be used while load handling devices complete other tasks. Conveniently, as illustrated in FIGS. 3-5, temporary storage locations 5 arranged adjacent to access aisles which may be primarily used for transport.

FIG. 7 illustrates a corner of the opposite end of the storage floor, relative to FIG. 4, of FIG. 3. Similarly to the first end, for the majority of the end row, the grid unit locations alternate between lay-bys 4 and temporary storage locations 5. In addition, the end row comprises maintenance area 3 and charge point locations 9. Charge points locations 9 are used to re-charge the power resource of the load handling devices. Conveniently, the charge points 9, lay-bys 4 and temporary storage locations 5 are located adjacent to access aisles 2.

It will be understood that the specific layout of the storage floor may be adapted to the building in which it is located. The proportion of different types and use of unit grid locations may be adjusted according to availability and need. Further, it will be appreciated that other layouts of the storage floor are anticipated in order to provide a system which operates efficiently. The precise lay out will depend on, the total capacity required for the storage system and the size and shape of the building. Some sections of the storage floor may be divided by partition walls and controlling doors (not shown).

It will be appreciated that global or facility wide environmental control facilities may be located at the ends of the aisles, above the floor in the ceiling, or in maintenance areas.

FIG. 8-12 illustrate a load handing device 301 for use in the storage system. The load handing device 301 is used for lifting and depositing storage containers 200 in locations within the system. Further, the load handing device 301 is used to transport storage containers 200 between locations.

FIG. 8 illustrates a plan view of a long side, or y-z side, of a load handling device, with a storage containers resting on the lifting pad, in various configurations. In FIG. 8a the y-direction wheels 303 are deployed with the x-direction wheels held in a raised position, for forward and reverse movement in the y-direction. Typically, load handling devices will transit in y-direction in the configuration shown in FIG. 8a.

In FIG. 8b the x-direction wheels 307 wheels are deployed, with the y-direction wheel held in a raised position, for forward and reverse movement in the x-direction. Typically, load handling devices will transit in x-direction in the configuration shown in FIG. 8b. Although the storage containers support pad 308 is slightly raised in the configuration shown in FIG. 8b compared to the configuration shown in FIG. 8a, the bottom of the storage container 200, if carried, is still below the top of the trestles.

In this way, when carrying a storage containers 200 the load handling device may move along any unobstructed pathway along the track network 306—typically access aisles where no trestles are present. For example, to leave the storage containers 200 in a location having trestles such as a temporary storage location or a storage location, or to retrieve a storage containers 200 to transfer the storage containers to a new location.

If a load handling device is in transit without carrying or supporting a storage container 200, then it the load handling device may move along any pathway along the track network 306, in some cases beneath storage containers resting on trestles.

FIG. 8c shows the load handling device 301 of FIGS. 8a and 8b, between a pair of trestles 311. In this configuration, the support pad 310 and storage containers 200 are raised so that the bottom of the storage containers 200 is above the top of the trestles 311. In the configuration shown in FIG. 8c, the load handling device 301 can either move on to the next location, or lower the storage containers 200 on to the trestles 311 before moving away to the next task. How the support pad 310 moves from lowered and raised positions is discussed in more detail below, in connection with FIG. 9.

FIG. 9 illustrates a side elevation view of the short side, or x-z side, of the load handing device 301 without a storage containers 200, and showing the lifting pad 310 and mechanism in more detail.

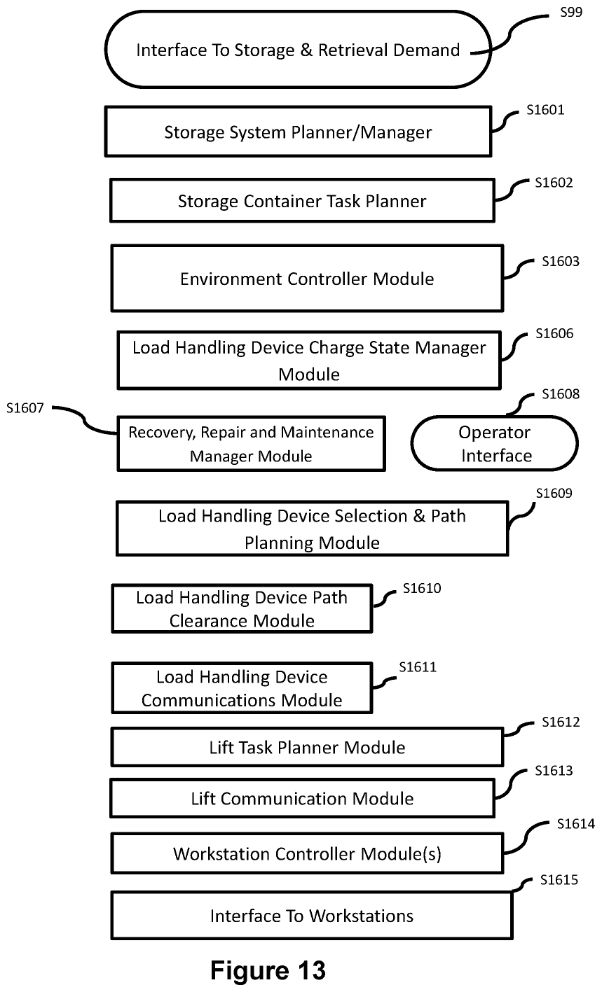

FIG. 10 illustrates an elevation view of a short side, or x-z side, of the load handing device with the moving sub chassis removed. FIG. 20 illustrates an elevation view of the long side, or y-z side, of an alternate load handling device design where the lift of load (tray) support pad to clear the trestles is accomplished with a third electric or hydraulic ram (305), which is independent from the two direction change mechanism rams. FIG. 12 illustrates a plan view of the underside, x-y, of the load handling device.

As shown in FIG. 9a, a ram mounting 327 is mounted to the load handling device chassis. The ram 331 illustrated comprises a first stage 329 and a second stage 330, nested within the first stage 329. It will be appreciated that the ram 331 is of a telescoping type. The upper extremity of the second stage 330 is mounted to a sub-chassis 312. In this way, the sub-chassis 312 may move up and down with the ram 331. The sub-chassis 312 is contained within a retaining flange 317, 323 and guided with needle or roller bearing 324, shown in FIGS. 9 and 10.

In FIG. 9a, the ram 331 is fully compressed or nested and the wheels 307 are in an x-direction drive position, and the support pad 310 is at the maximum height. In FIG. 9b, the ram 331 is partially expanded or raised, and the wheels 307 are in a drive position, and the support pad 310 is at the minimum height for x-direction drive. In FIG. 9c, the ram 331 is fully extended and the wheels 307 are in a raised position (for y-direction drive by the wheels 303). In this way, the same mechanism is used to raise and lower the support pad 310 and control the x-y direction of the load handling device 301.

One or more displacement sensors 304, 326 may monitor the distance travelled by the load handling device in the y- and x-directions respectively.

FIG. 10 illustrates a side elevation view of a short side, or x-z side, of the load handing device with the moving sub chassis removed.

FIG. 11 illustrates a side elevation view of the long side, or y-z side, of an alternate load handling device design where the lift of storage container support pad to clear the trestles is accomplished with a third electric or hydraulic ram 305, which is independent from the two direction change mechanism rams.

FIG. 12 illustrates a plan view of the underside, x-y, of the load handling device 301. As may be seen, wheels 303 are arranged along the along the long sides of the device 301 for y-direction travel, and wheels 307 are arranged along the short sides of the device attached to the sub-chassis 312 held within the retaining frame 317. At the centre of the device 301 a camera 316 is positioned for monitoring the positioning and travel of the device 301.

FIG. 13 is a schematic diagram of a controller for the storage system. As noted above, the controller or control facility may comprise a number of software programs running on separate computing devices, interlinked by communication facilities. Any suitable architecture is anticipated as would be well understood by a person skilled in the art. Accordingly, the controller is shown as a number of separate modules.

S99 shows an Interface to the Storage & Retrieval Demand, to allow an operator or interfaced order management system to input desired actions of the system to be communicated to other modules of the system.

A is not shown. S1601 shows a Storage System Planner/Manager, to collectively manage the components of the storage system, to plan tasks to work towards desired outcomes of the system and to send instructions to other modules.

S1602 shows a Storage Container Task Manager, to plan and send instructions to load handling devices and workstations.

S1603 shows an Environment Controller Module to manage and control environmental parameters in aisles, on a storage floor and within chambers.

S1606 shows a Load Handling Device Charge State Manager Module, to schedule load handling devices visits charge points when necessary, to ensure that load handling devices are not re-tasked before they have adequate charge from the charge points, and to ensure the load handling devices are not selected to undertake a task for which they do not have adequate battery or supercapacitor charge.

S1607 shows a Recovery, Repair and Maintenance Manager Module, to manage the operational capability of the fleet of load handling devices and manage necessarily work to maintain functionality.

S1608 shows an Operator Interface, for users to link to components of the system to provide inputs for desired operations, data, and feedback to the operator.

S1609 shows a Load Handling Device Selection & Path Planning Module, to plan routes for load handling devices to complete tasks.

S1610 shows a Load Handling Device Path Clearance Module, to ensure that during execution of the planed routes do not conflict and are free of obstruction.

S1611 shows a Load Handling Device Communication Module, for receiving instructions from other modules and for transmitting data to other modules.

S1612 shows a Lift Task Planner Module, for providing capability to move load handling devices between floors.

S1613 shows a Lift communication Module, for receiving instructions from other modules and for transmitting data to other modules,

S1614 shows a Workstation Controller Module(s), for planning and executing tasks to process storage containers.

S1615 shows an Interface To Workstations, to allow for user input and communication from the system to automated workstations and to operators working at manual workstations.

### Further Comments

It will be appreciated that, the storage system described herein provides a moderate to high density storage facility. Accordingly, the facility provides an efficient and cost effective use of land.

The vertical scalability of the facility is only limited by building technology or construction practices, rather than by the storage facility and system itself.

It will be appreciated that, advantageously, the storage arrangement is relatively simple in design, with minimal interaction or connectivity required between mechanical components. storage It may be possible to construct the facility within existing buildings, or within multi-function buildings.

It will be appreciated that the arrangement of storage locations advantageously provides for rapid or random access to each of the storage containers while maintaining a relatively high density of storage.

It will be appreciated that the number of storage locations on the side-aisles may be optimised based on the intended use.

It will be appreciated that the load handling devices are simple and accordingly may provide improvements in reliability compared with other systems.

It will be appreciated that the cost and or number of MHE requirement, or load handling devices, may be minimised by optimisation of the system's control facility.

It will be appreciated that control of temperature, humidity and gaseous composition eg. nitrogen concentration of the atmosphere on an aisle-by-aisle basis; or part of aisles e.g. galleries or chambers basis, may provide efficiencies and simplifications. Accordingly, a cost benefit may follow.

It will be appreciated that very large containers such as shipping containers are difficult to store and retrieve in a cubic storage and retrieval system such as described in the existing art. It will be appreciated that failure of a Z-lift hoist would require a difficult recovery of a container and or load handling device within the system. The substantially single layer system disclosed herein avoids this problem while providing a high density storage and retrieval system.

Advantageously, the system readily supports full automation at the workstations as the load handling devices provide conveyance through workstations. The workstation may be automated or robotic.

Within the system, fire suppression is easily engineered, and within storage areas firewalls are easily engineered, thereby improving the safety of the system.

The storage and retrieval system described above with reference to the figures allows control of the growing environment. In addition, the modular nature of the system allows for efficient use of space and is ready scalability. The length, width and height of the track grid system can be chosen to fit the available space.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that a storage system, method and devices can be designed for a particular application using various combinations of devices and arrangements described above. It will be appreciated that the features described herein above may all be used together in a single system. In other embodiments of the invention, some of the features may be omitted. The features may be used in any compatible arrangement. Many variations and modifications not explicitly described above are possible without departing from the scope of the invention as defined in the appended claims.

In this document, the term “load handling device” and “bot” may be used interchangeably. The storage container may be a tray and the load handling device may be a tray handling device. The load handling device is a type of MHE or material handling equipment.

In this document, the language “movement relative to a gap” is intended to include movement within the gap, e.g. sliding along the gap, as well as movement into or out of a gap.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “xis connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “xis composed of y” will be used, meaning that x includes only y and nothing else.

1. A load handling device configured for operating in a storage system, a floor of the storage system including a network of tracks, or track network, based on a grid system, the tracks including a first set of track members extending in a first (x-) direction, and a second set of track members extending in a second (y-) direction, the second set of track members running transversely to the first set of track members in a substantially horizontal plane, the load handling device comprising:
a first set of wheels arranged for engaging with a track network having a first set of track members extending in a first direction;
a second set of wheels arranged for engaging with a second set of track members extending in a second direction of the track network, wherein the load handling device is configured to be driveable in the first or second direction to any location on the track network; and
a support pad for receiving storage container wherein the support pad is configured to be raised and or lowered in a vertical (z-) direction.

2. A load handling device according to claim 1, wherein the first set of wheels and or the second set of wheels comprise:
two or more wheels on each side.

3. A load handling device according to claim 1, comprising:
a suspension means for one or more of the wheels.

4. A load handling device according to claim 1, wherein the wheels are aligned in the first (x-) direction or aligned in the second (y-) direction and the wheels comprise:
caster wheels.

5. A load handling device according to claim 1, comprising:
a re-chargeable battery and or super capacitor for powering a drive motor; and
inductive charging pads wherein the re-chargeable battery and/or super capacitor is charged through the inductive charging pads which are positioned on an underside of the load handling device.

6. A load handling device according to claim 1, comprising:
a drive for having each or all the wheels of the first set of wheels and the second set of wheels.

7. A load handling device according to claim 1, comprising:
locking means for locking one or more of the first set of wheels and the second set of wheels.

8. A load handling device according to claim 1, comprising:
at least one or more of: a RFID reader; a scanner; and/or camera, for reading an identify tag or label.

9. A load handling device according to claim 1, wherein the load handling device in combination with a supported storage container, has a footprint that occupies only a single grid space in the storage system.

10. A load handling device according to claim 1, comprising:
navigation means for monitoring and controlling motion along the track network.

11. A load handling device according to claim 1, comprising:
a communication means for receiving instructions from a central control facility and for transmitting data.

12. A load handling device according to claim 1, comprising:
a proximity sensor.

13. A control facility for controlling a load handling device according to claim 1, the control facility being configured for controlling the load handing device.

14. A method of using a storage system, a floor of the storage system including: a network of tracks, or track network, based on a grid system, the tracks including a first set of track members extending in a first (x-) direction, and a second set of track members extending in a second (y-) direction, the second set of track members running transversely to the first set of track members in a substantially horizontal plane, and at least one load handling device operating thereon, wherein the method comprises one or more steps of:
lifting, transporting and depositing storage containers using a load handling device according to claim 1;
depositing a storage container in a storage location;
retrieving a storage container from a storage location;
arranging storage containers in storage aisles according to required atmospheric conditions; and/or
controlling the environment in storage aisles according to storage requirements of the storage container.

15. A load handling device according to claim 1, in combination with a storage system having a floor which comprises:
a first set of track members extending in a first (x-) direction, and a second set of track members extending in a second (y-) direction, the second set of track members running transversely to the first set of track members in a substantially horizontal plane.

16. A control facility for controlling a load handling device according to claim 15, the control facility being configured for controlling the load handing device.

17. A load handling device according to claim 2, comprising a re-chargeable battery and or super capacitor for powering a drive motor; and
inductive charging pads wherein the re-chargeable battery and/or super capacitor is charged through the inductive charging pads which are positioned on an underside of the load handling device.

18. A load handling device according to claim 17, comprising:
a drive for having each or all the wheels of the first set of wheels and the second set of wheels.

19. A load handling device according to claim 18, comprising:
navigation means for monitoring and controlling motion along the track network.

20. A load handling device according to claim 19, comprising:
a communication means for receiving instructions from a central control facility and for transmitting data.
